(19) United States
(12) Patent Application Publication
(10) Pub. No.: US 2017/0373962 A1
(43) Pub. Date: Dec. 28, 2017

(54) Cloud-Based Wireless Testing via Custom Test APN, P-GW, ePDG and IMS

(71) Applicant: Spirent Communications, Inc., Sunnyvale, CA (US)

(72) Inventors: Michael C. Keeley, Sunnyvale, CA (US); Kurt E. Bantle, Sunnyvale, CA (US); Saul J. Einbinder, Sunnyvale, CA (US)

(73) Assignee: Spirent Communications, Inc., Sunnyvale, CA (US)

(21) Appl. No.: 15/244,531

(22) Filed: Aug. 23, 2016

Related U.S. Application Data
(60) Provisional application No. 62/369,670, filed on Aug. 1, 2016.
(60) Provisional application No. 62/354,037, filed on Jun. 23, 2016.

(51) Int. Cl. H04L 12/26; H04L 29/12; H04L 12/24; H04W 24/08; H04L 29/06

(52) U.S. Cl. CPC H04L 43/50; H04W 24/08; H04L 65/1016; H04L 41/5038; H04L 61/1511; H04L 65/1006

(57) ABSTRACT

The disclosed systems and methods use a public eNodeB to access a private P-GW, IMS and ePDG for testing purposes. The method of testing a DUT teaches loading the DUT with a designation of a test APN to access through a cellular or WiFi calling network. The APN names a test P-GW controlled by a testing entity—the P-GW name resolvable by accessing a GRX. The test P-GW is specially adapted to testing and providing control over tests. The DUT initiates contact with the network to establish an end-to-end IP connection through the P-GW designated by the APN. The P-GW generates test error conditions and codes during establishment of the connection, and can include attack messages, payloads and recording responses of the DUT to the APN attack messages and payloads. For other tests, the end-to-end connection is established, test traffic is carried over the connection, and test analysis is performed.

### RELATED APPLICATION

This application is related to, and claims the benefit of U.S. Provisional Patent Application No. 62/369,670, filed 1 Aug. 2016, entitled “CLOUD-BASED WIRELESS TESTING VIA CUSTOM TEST APN AND P-GW,” by Michael C. Keeley, Kurt E. Bantle, and Saul J. Einbinder and U.S. Provisional Patent Application No. 62/354,037, filed 23 Jun. 2016, entitled “CLOUD-BASED WIRELESS TESTING VIA CUSTOM TEST APN AND P-GW,” by Michael C. Keeley, Kurt E. Bantle, and Saul J. Einbinder both of which are incorporated by reference herein.

### BACKGROUND

Wireless chipset vendors, device manufacturers, and service providers need to be able to measure and improve the quality of experience (QoE) for the wireless user, and address issues of end-to-end IP connectivity via packet data network gateways and the complex interoperability challenges of IMS-based services. Cost effective and comprehensive testing support is needed for applications across the industry and throughout all stages of device development life cycle.

Current wireless device development and validation testing techniques make use of a sophisticated instrument, co-located with the DUT. That is, the existing testing environment often incorporates a costly physical instrument that incorporates the functionality of multiple entities. This way of testing implements multiple virtual machines and firmware for completing development and validation. The functionality includes device-to-device testing, comprehensive QoE and in-depth analytics. Device-to-device testing includes interoperability testing of multiple devices over LTE and WiFi—covering IP multimedia subsystem (IMS), voice over LTE (VoLTE) and rich communication services (RCS) call functionality with true VoLTE dedicated bearer representation and carrier-modeled IMS networks. Comprehensive QoE metrics for end-to-end tests enable voice and video quality, call performance, battery performance and data throughput in both the lab and live network. In-depth analytics are needed to resolve issues and improve the quality of an application being developed and validated. For other use cases, a different physical computing device is required for each functional need.

In one use case, small companies developing IoT devices such as “smart” parking meters, electric meters and car charging stations, need to gain convenient affordable access to wireless device development and validation testing techniques and services on an as-needed basis. Needed tests can include, among others, end-to-end connectivity, comprehensive QoE metrics and in-depth analytics, and device-to-device interoperability testing of multiple devices over LTE and WiFi—covering IMS, VoLTE and RCS call functionality.

An opportunity arises to provide systems and methods for cloud-based wireless testing via custom test APN and P-GW, custom test ePDG, and custom test IMS Network.

### SUMMARY

The disclosed technology offers systems and methods for using a public eNodeB to access a private P-GW, IMS and ePDG for testing purposes.

One implementation of the disclosed technology teaches a method of testing a wireless device (DUT), including loading the DUT with a designation of a test APN to access through a cellular or WiFi calling wireless network. The test APN names a test P-GW controlled by a testing entity. The APN name of the test P-GW is resolvable by accessing a GRX or cache from a GRX or a cellular carrier internally-configured routing table. The test P-GW is specially adapted to testing and providing control over tests. The DUT initiates contact with the wireless network to establish an end-to-end IP connection from the DUT through the test P-GW designated by the test APN. The test P-GW can generate test error codes and/or error conditions during establishment of the end-to-end connection for some tests. For other tests, the end-to-end connection is established, test traffic is carried over the connection, and test analysis is is performed. For some implementations, the end-to-end test includes an IMS test scenario, and for some implementations, the test server is an IMS server.

Some disclosed methods of testing a wireless DUT include loading the DUT with a designation of a test IMS CSCF domain name to access through a wireless calling network that is a cellular wireless network or a data channel of a WiFi calling network. The test IMS CSCF domain name specifies a test IMS Network controlled by a testing entity; and the name of the test IMS CSCF is resolvable by accessing a DNS or cache from a DNS. For the disclosed method, the test IMS Network is specially adapted to testing and providing control over tests; with the DUT initiating contact with the wireless network to establish an end-to-end IMS Session from the DUT through the test IMS Network designated by the test IMS CSCF domain name; and receiving from the test IMS Network error conditions and recording response of the DUT to the error conditions. The disclosed method also includes receiving from the test IMS Network a valid communication channel and performing SIP Protocol tests; and receiving from the test IMS Network a valid communication channel and performing inter-carrier interoperability tests. The disclosed method can further include testing a prototype wireless DUT.

Other disclosed methods of testing a wireless DUT include loading the DUT with a designation of a test IMS CSCF domain name, to access through a WiFi wireless network, which specifies a test IMS Network controlled by a testing entity. The name of the test IMS CSCF is resolvable by accessing a DNS or cache from a DNS; and the test IMS Network is specially adapted to testing and providing control over tests. The disclosed method includes the DUT initiating contact with the wireless network to establish an end-to-end IMS Session from the DUT through the test IMS Network designated by the test IMS CSCF domain name; and receiving from the test IMS Network error conditions and recording response of the DUT to the error conditions. The name of the test ePDG is resolvable by accessing a GRX or cache from a GRX or a cellular carrier internally-configured routing table. The method can further include receiving from the test IMS Network a valid communication channel and performing SIP Protocol tests, and can also include receiving from the test IMS Network a valid communication channel and performing inter-carrier interoperability tests. The disclosed method can further include testing a prototype wireless DUT.

Particular aspects of the technology disclosed are described in the claims, specification and drawings.

### BRIEF DESCRIPTION OF THE DRAWINGS

FIG. 1 shows an example existing live network deployment architecture environment.

FIG. 2 shows the live network deployment architecture with cloud-based evolved packet core hosted test functions.

FIG. 3 illustrates a WiFi implementation of the live network deployment architecture with cloud-based evolved packet core hosted test functions.

FIG. 4 illustrates an IMS core usable for cloud-hosted testing for DUT and applications.

FIG. 5 is a simplified block diagram of a system usable for cloud-based wireless testing via custom test APN and P-GW.

### DETAILED DESCRIPTION

The following description of the disclosure will typically be with reference to specific embodiments and methods. It is to be understood that there is no intention to limit the disclosure to the specifically disclosed embodiments and methods, but that the disclosure may be practiced using other features, elements, methods and embodiments. Preferred embodiments are described to illustrate the present disclosure, not to limit its scope. Those of ordinary skill in the art will recognize a variety of equivalent variations on the description that follows. Like elements in various embodiments are commonly referred to with like reference numerals.

Historically, wireless device and application development and testing used an existing environment that includes a single physical instrument—such as Spirent Communication's wireless test system—to aid in the development and validation of a mobile device (DUT). The wireless test system includes a network emulator that can include an ASIC that provides the PHY layer as part of eNodeB, and a first virtual machine that completed the functionality of eNodeB. A second virtual machine emulates the evolved packet core, and a third virtual machine emulates an IMS network. A DUT with a test SIM with simulator credentials would communicate with the simulator—a hardware instrument with embedded firmware. The simulator would emulate the functions of the radio access network (RAN), packet core network and IMS, when applicable. The entirety of the simulator would need to be present with and local to each DUT.

The disclosed technology makes available an alternative to the channel emulator features designed earlier—offering affordable, convenient access to wireless device development and validation testing techniques and services on an as-needed basis in a test cloud environment. The disclosed technology includes a DUT with a test SIM with a mix of live RAN plus cloud infrastructure credentials. The SIM parameters and APN configuration in the DUT allow traffic from the live RAN to be routed to hosted network entities—both packet core network and IMS server entities. Data routed to and from hosted entities can be monitored and manipulated to complete desired test scenarios, described later.

Acronyms used in this disclosure are identified the first time that they are used. These acronyms are terms of art, often used in standards documents. Except where the terms are used in a clear and distinctly different sense than they are used in the art, we adopt the meanings found in wireless standards. For the reader's convenience, many of them are listed here:

APN Access Point Name

CSCF Call Session Control Function

DNS Domain Name Service

DUT Device Under Test

eNodeB An Element of a LTE Radio Access Network

EPC Evolved Packet Core

ePDG Evolved Packet Data Gateway

E-UTRAN Evolved Universal Terrestrial Radio Access Network

GPRS Global Packet Radio Service

GRX Global Roaming Exchange

GSM Global System for Mobile Communication

HSS Home Subscriber Server

I-CSCF Interrogating-CSCF

IMS IP Multimedia Subsystem

LTE Long Term Evolution

MGCF Media Gateway Controller Function

MME Mobile Management Entity

MMS Multimedia Messaging Service

MNO Mobile Network Operator

NAPTR Name Authority Pointer

PCRF Policy and Rules Function

P-CSCF Proxy-CSCF

PDN Packet Data Network

P-GW Packet Data Network Gateway

PHY Physical Layer of the OSI Model

QoE Quality of Experience

RAN Radio Access Network

RCS Rich Communication Services

S-CSCF Serving-CSCF

SGW Serving Gateway

S-GW Serving Gateway

SIP Session Initiation Protocol

SRV Service Record

UE User Equipment

VoIP Voice over Internet Protocol

VoLTE Voice Over LTE

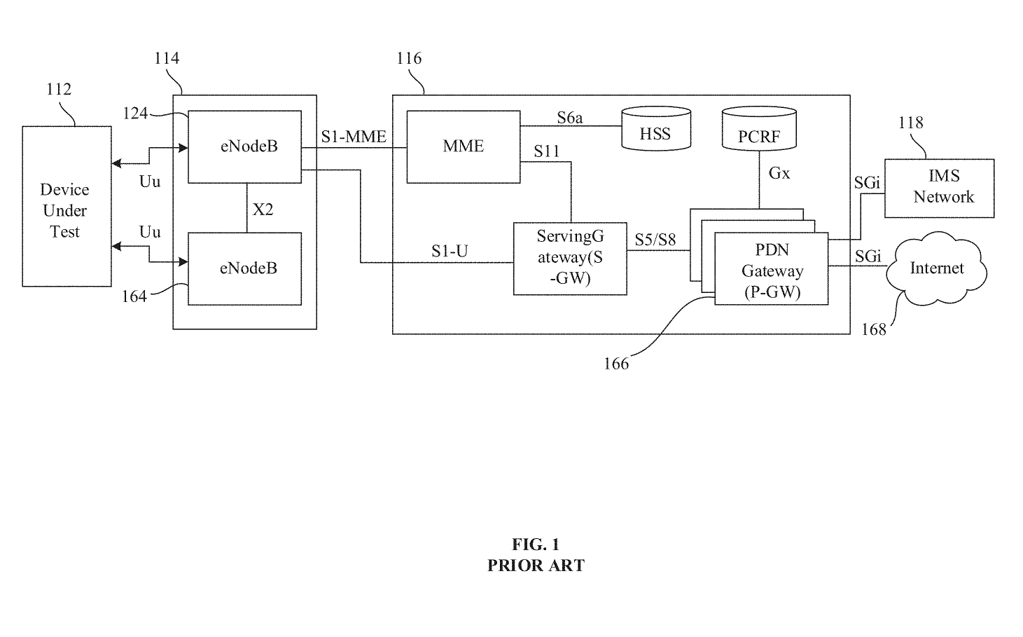

FIG. 1 illustrates an example existing live network deployment architecture, which contains a device under test (DUT) 112 coupled in communication with evolved universal terrestrial radio access network (E-UTRAN) base station tower 114 with eNodeBs 124, 164. Example DUTs can include smart phone or other mobile devices that connect to the Internet. Evolved packet core (EPC) 116 includes PDN gateways (P-GW) 166 to the Internet 168, an IMS Network 118, and can include various other networks, including those dedicated to a company's non-public intranet. Many of the components in the cellular network are hosted on special purpose computing platforms that have sufficient computing power and I/O to accommodate the extremely large number of connections to a data network. One example Packet Data Network Gateway is Cisco ASR 5000 Multimedia Core Platform. As general purpose platforms evolve, and for relatively low volume tests, software can be run on a variety of platforms that have sufficient I/O resources and processing scale. Some of the components can be deployed as preconfigured virtual servers, deployable as scaling requires or to accommodate individual entities requiring tests. If a general purpose platform is used, at least the optimizations to the OS kernel are useful to adapt to the number of connections required.

PDN gateway 166 is a device that routes traffic via an access point name (APN), providing connectivity to another network such as the Internet 168 or IMS Network 118. Using virtualization, a single physical device with multiple virtual machines can provide service to multiple gateways. The APN is the name of a gateway between a GSM, GPRS, 3G or 4G mobile network and another computer network, frequently the public Internet. A mobile device making a data connection must be configured with an APN to present to the carrier. The carrier will then examine this identifier to determine what type of network connection needs to be created; for example, which IP addresses should be assigned to the wireless device, which security methods should be used, and how or if it should be connected to some private customer network. More specifically, the APN identifies which packet data network (PDN) a mobile data user wants to communicate with. In addition to identifying a PDN, an APN may also be used to define the type of service, such as connection to wireless application protocol (WAP) server or multimedia messaging service (MMS) that is provided by the PDN. APN is used in 3GPP data access networks including global packet radio service (GPRS) and evolved packet core (EPC).

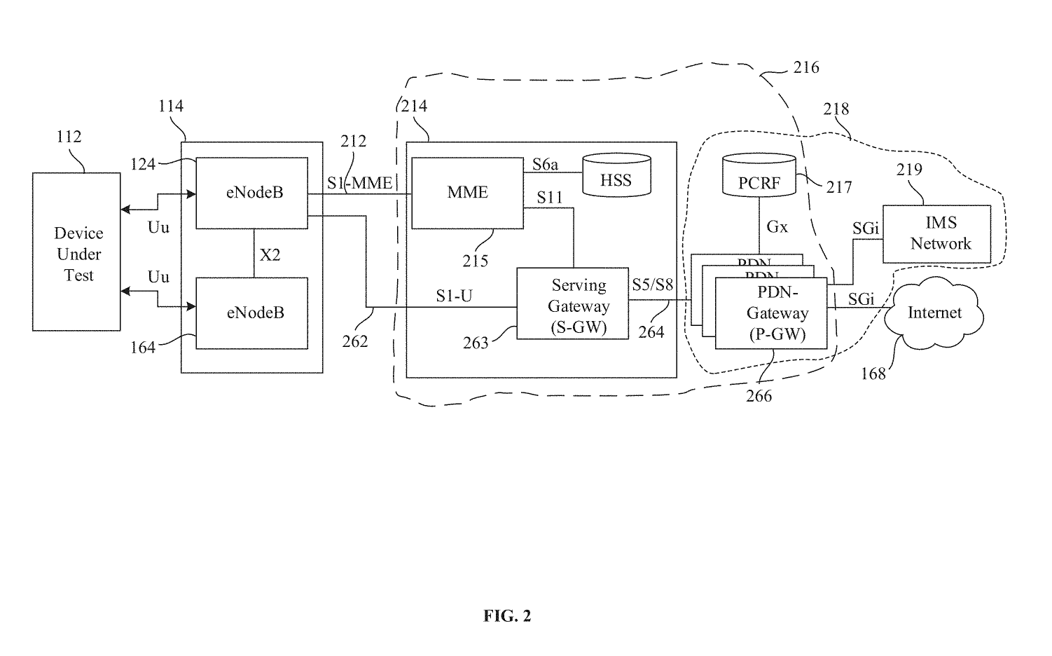

The disclosed technology includes an evolved packet core (EPC) which includes hosted cloud test functions in place of the typical live network deployment architecture. FIG. 2 shows the live network deployment architecture EPC 116 of FIG. 1, with EPC 116 changed by dividing the functionality into two parts. The disclosed EPC live network 214 connects to hosted cloud EPC test functions 218 via the S5/S8 serving gateway protocol 264. Test signals come in over the E-UTRAN live network 124 (Verizon, AT&T, etc.) via mobility management entity protocol S1-MME 212 to the live mobility management entity (MME) 215 and via S1-U interface 262 to serving gateway (S-GW) 263. Test signals from S-GW 263 are routed to the disclosed hosted PDN gateway, P-GW 266, and forwarded to hosted IMS Network 219, instead of going to the live PDN gateway (P-GW) 166 shown in FIG. 1. In another implementation, a cellular carrier internally-configured routing table can be included for accessing hosted IMS Network 219. The routing table can be implemented as a data table that lists the routes to particular network destinations usable for testing.

In one example, a DUT submits an APN in a PDN connectivity request. The serving gateway, S-GW 263, forwards the PDN connectivity request to PDN Gateway P-GW 266, which accesses the policy and rules function (PCRF) 217 to decide whether or not to honor the request. The PCRF software node is designated to determine policy rules in a multimedia network in real-time, accessing subscriber databases and other specialized functions, such as a charging system. For example, a rejection error can be generated if a user attempts to access an intranet for which they have not been granted authority, or a service for which they have not paid a subscription fee. The DUT connectivity request typically gets submitted to multiple PDNs simultaneously, so multiple IP addresses are commonly assigned to the DUT. For example, a LTE DUT makes a VoLTE call managed by an IMS Network so uses an IMS Network PDN, and smart phone DUT requests to browse access a separate PDN gateway for Internet traffic. The two services for the single DUT use two separate IP addresses.

In one example use case, a car manufacturer includes a new audio tuning application in their newly released vehicles. The manufacturer needs to connect the tuning application to a private network that serves the new car buyers, so needs to test the P-GW to confirm that the connection provided for the application is not distributed to the general public.

Global roaming exchange (GRX) providers act as a trusted partner between mobile network operators (MNOs), such as AT&T and Verizon, shown in FIG. 2 as E-UTRAN live network 114 and MME 215 and S-GW 263 of the EPC 216, and P-GW 266. That is, the GRX provider handles the routing task. Most GRX providers use a straightforward DNS-like query mechanism to resolve the routing. For instances in which the new APN designates the P-GW, and the APN resolves to an approved IP address, the routing is readily accepted.

Mobile subscribers want access to the Internet at home, work, hotspots, and everywhere in between, and they expect the same quality of experience and access to the same services regardless of access type. At the same time, we are in the midst of a mobile data surge that is placing strains on cellular resources, and promoting expanded service over unsecure, untrusted WiFi access networks. Some cellular carriers offload excess load to WiFi networks when WiFi is available.

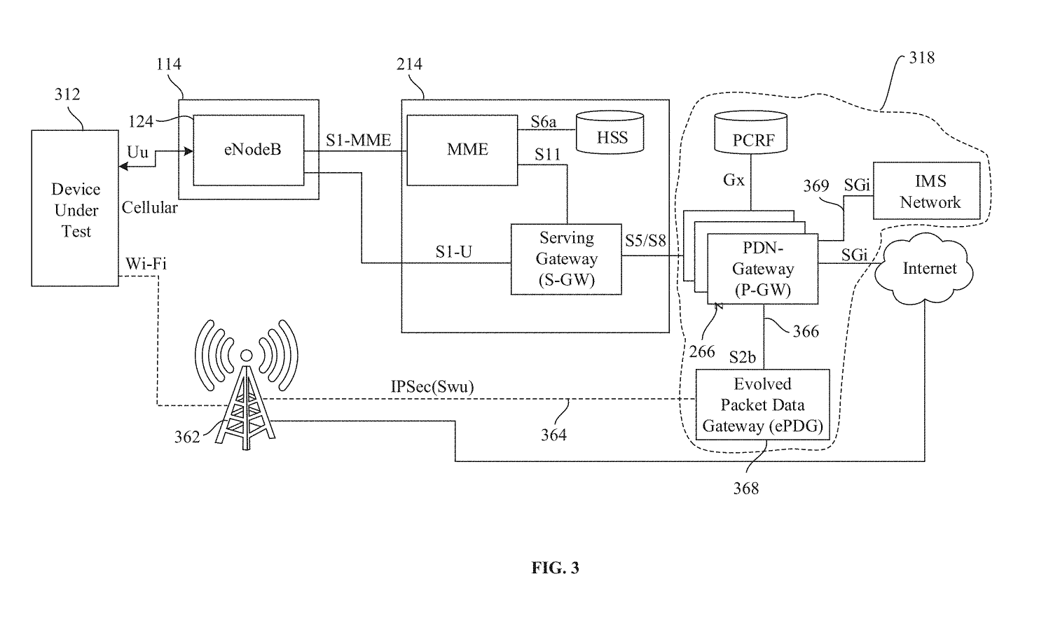

FIG. 3 illustrates an example WiFi implementation of the disclosed test environment, with the WiFi network in parallel with the E-UTRAN live network. When the untrusted WiFi access point (WAP) 362 replaces the E-UTRAN live network 124, and communicates packets to evolved packet data gateway (ePDG) 368, via Internet protocol security (IPSec) 364, the packets bypass the EPC 214 in route to hosted cloud test functions 318. Test signals come into ePDG 368 which communicates with PDN gateway P-GW 266 via S2b interface 366. In the WiFi scenario, DUT 312 is provisioned with the domain name of the test ePDG 368, configurable and controllable to create test scenarios that the service provider wishes DUT 312 to use. When DUT 312 is using a service, such as IMS VoLTE, over untrusted WAP 362, the service will do a DNS name resolution of the provisioned ePDG name, and then establish an IPSec tunnel 364 to that resolved ePDG address. In addition to the ePDG domain name, DUT 312 will also have been provisioned with the necessary authentication variables to allow the IPSec tunnel to be negotiated. Using the same process used for cellular routing to the test P-GW, the tester provisions DUT 312 with a test ePDG name and DUT 312 chooses to route to the test ePDG instead of routing to the commercial network ePDG. In some implementation, a cellular carrier internally-configured routing table can be included for accessing hosted cloud test functions 318.

The disclosed technology for cloud-based wireless testing via custom test APN and P-GW, for both cellular and WiFi wireless networks includes testing the response of the DUT to error conditions during establishment of the end-to-end IP connection from the DUT to the test P-GW/ePDG. The disclosed methods include receiving, from the test APN, error conditions and recording responses of the DUT to the error conditions. Other methods include opening a valid communication channel and performing an end-to-end test between the DUT and a test server. Example tests include (1) network fails to assign an IP address to the UE, so no response, leading to back-off or malformed responses; (2) UE receives PDN connectivity reject message from the network, causable by network congestion, authentication failure, or other errors, and can be a temporary or permanent error; (3) network fails to respond to PDN connectivity request; and (4) network fails to refresh the IP address. The four examples listed are a subset of an extensive set of well-defined test examples in “Verizon Wireless LTE Data Retry Test Plan”, Chapters 6 and 7, found in “LTE Data Retry_Test_Plan_2016.pdf” <accessed at https://odi-device.verizonwireless.com/info/Open%20Development%20Device%20Docs/OpenAccessDocs/Verizon_Wireless_700MHz_C_Block_LTE_Specifications.zip>. The Chapters 6-7 are hereby incorporated by reference.

For the disclosed cloud-based wireless testing via custom test APN and P-GW, additional tests can measure and monitor cybersecurity issues, emulating and analyzing the effects of corrupt and malicious traffic on IoT devices. These IoT security-related tests can include distributed denial of service (DDoS), worms, malware, application penetration, port scanning, port corruption, buffer overflows, protocol exploitation, fuzzing and man-in-the-middle attacks. The attack knowledge base continuously receives updates with new exploits. Disclosed technology methods also include receiving from the test APN, attack messages and payloads and recording responses of the DUT to the APN the attack messages and payloads. In many test cases, attack (or erroneous) messages occur at specific times as prescribed by the test case documentation. For example, when the mobile requests a data channel, send the erroneous message in response to that specific request. However, as security threat related tests are included, completely asynchronous attack messages can be sent to the UE in an unpredictable pattern.

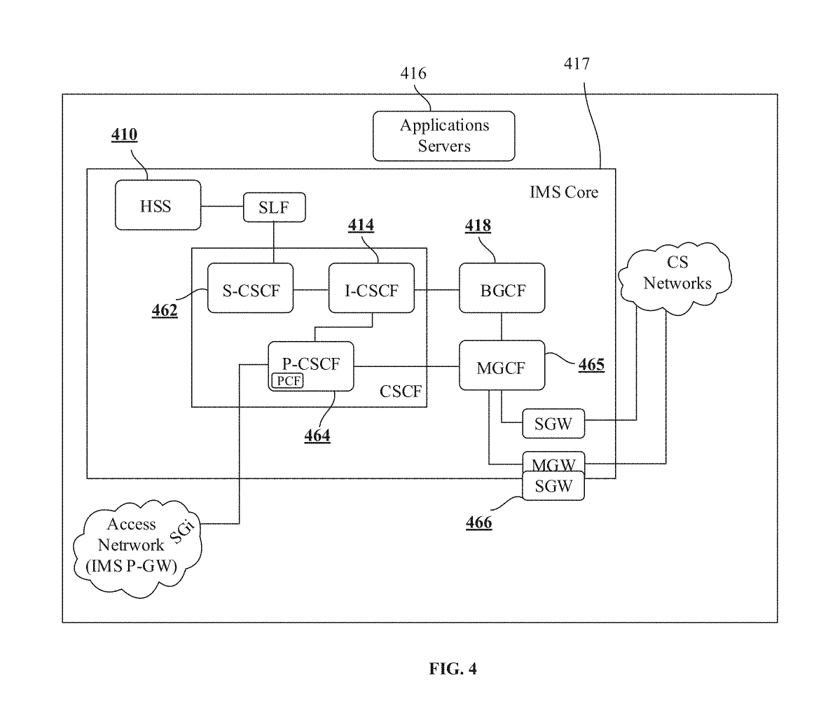

FIG. 4 illustrates an IMS core 417 usable for cloud-hosted testing for DUT and applications servers 416, for the disclosed technology. As described earlier, the DUT is loaded with a designation of a test IMS CSCF domain name/IP address to access through a cellular or WiFi wireless network. The CSCF is responsible for the signaling controlling the communication of IMS User Equipment (UE) with IMS enhanced services across different network accesses and domains. The CSCF controls the session establishment and teardown, as well as user authentication, network security and QoS. P-CSCF 464 is the first point of contact between the UEs and the IMS Network. Acting as a session initiation protocol (SIP) proxy, the SIP requests and responses from/to UEs traverse the P-CSCF 464.

I-CSCF 414 is a SIP proxy located in the edge of an administrative IMS domain. Its IP address is published in the Domain Name System (DNS) of the domain (using Name Authority Pointer (NAPTR) and Service Record (SRV) type of DNS records), so that remote servers can find and use it as a forwarding point (e.g., registering) for SIP packets to this IMS domain. I-CSCF 414 implements a diameter (RFC 3588) interface to Home Subscriber Server (HSS) 410, and queries HSS 410 to retrieve the address of S-CSCF 462 for an UE to perform SIP registration. As a SIP proxy, I-CSCF 414 forwards SIP message requests and responses to S-CSCF 462. Additionally, I-CSCF 414 may encrypt parts of the SIP messages securing any sensitive information. The test IMS CSCF domain name/IP address specifies a test IMS Network controlled by a testing entity. The name of the test IMS CSCF is resolvable by accessing a DNS or cache from a DNS. The test IMS Network is specially adapted to testing and providing control over tests. The DUT initiates contact with the wireless network to establish an end-to-end IMS Session from the DUT through the test IMS Network designated by the test IMS CSCF domain name/IP address. Breakout Gateway Control Function BGCF 418 is a SIP proxy which processes requests for routing from S-CSCF 462 when S-CSCF 462 has determined that the session cannot be routed using DNS or ENUM/DNS. Media gateway controller function (MGCF) 465 is a SIP endpoint that does call control protocol conversion between SIP and ISUP/BICC and interfaces with the SGW 466.

Example IMS server controlled tests consider the response of the DUT to error conditions during establishment of the IMS session, and also after the end-to-end IP connection from the DUT to the test P-GW and ePDG is established. The disclosed technology includes receiving from the test IMS Network error conditions and recording responses of the DUT to the error conditions; and receiving from the test IMS Network a valid communication channel and performing SIP Protocol tests and inter-carrier Interoperability tests. Example IMS Network tests include (5) IMS registration retry, network rejects request; and (6) UE initiated device IMS re-registrations with or without a network challenge. Extensive IMS Session test examples are included in “LTE IMS Registration and Retry_Test_Plan_MAR2016.pdf”. SMS is conducted over IMS in LTE. Additional example tests from plans for SMS can be implemented: “LTE 3GPP Band13 Data Throughput_Test_Plan_MAR2016” and “LTE SMS_Test_Plan_MAR2016”. All of these example tests were accessed at <https://odi-device.verizonwireless.com/info/Open%20Development%20Device%20Docs/OpenAccessDocs/Verizon_Wireless_700MHz_C_Block_LTE_Specifications.zip> and are incorporated by reference.

### Computer System

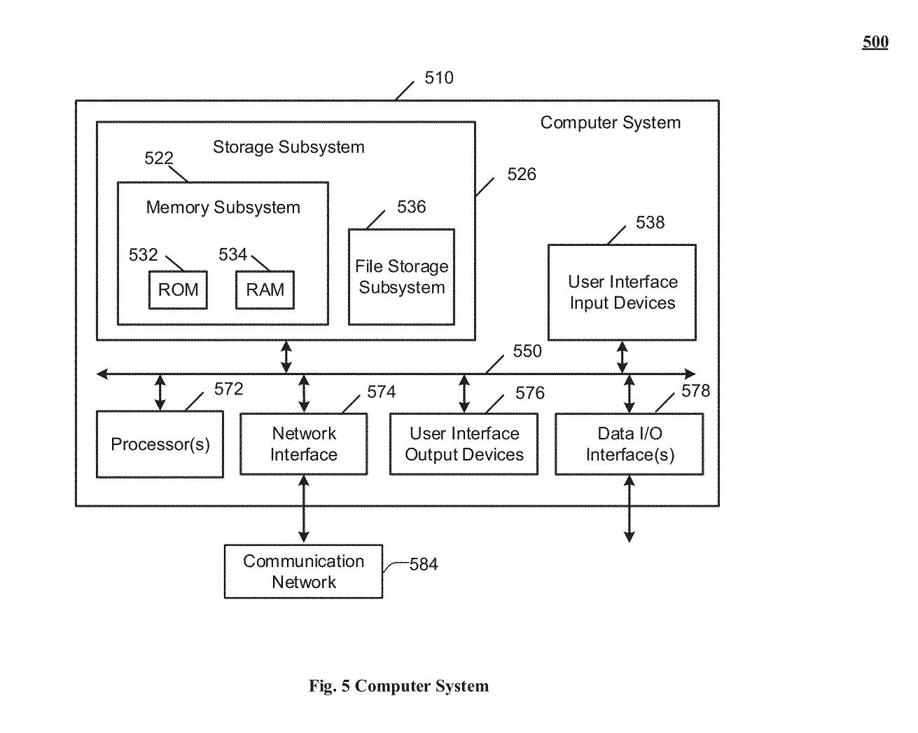

FIG. 5 is a simplified block diagram of an embodiment of a system 1000 that can be used for cloud-based wireless testing via custom test APN and P-GW. Cloud-based wireless testing of DUT and applications via custom test APN and P-GW can be implemented using a computer program stored in system memory, or stored on other memory and distributed as an article of manufacture, separately from the computer system.

Computer system 510 typically includes a processor subsystem 572 which communicates with a number of peripheral devices via bus subsystem 550. These peripheral devices may include a storage subsystem 526, comprising a memory subsystem 522 and a file storage subsystem 536, user interface input devices 538, user interface output devices 578, and a network interface subsystem 576. The input and output devices allow user interaction with computer system 510 and network and channel emulators. Network interface subsystem 574 provides an interface to outside networks and devices of the system 500. The computer system further includes communication network 584 that can be used to communicate with user equipment (UE) units; for example, as a device under test.

The physical hardware component of network interfaces are sometimes referred to as network interface cards (NICs), although they need not be in the form of cards: for instance they could be in the form of integrated circuits (ICs) and connectors fitted directly onto a motherboard, or in the form of microcells fabricated on a single integrated circuit chip with other components of the computer system.

User interface input devices 538 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into computer system 510.

User interface output devices 578 may include a display subsystem, a printer, a fax machine, or non-visual displays such as audio output devices. The display subsystem may include a cathode ray tube (CRT), a flat panel device such as a liquid crystal display (LCD) or LED device, a projection device, or some other mechanism for creating a visible image. The display subsystem may also provide non visual display such as via audio output devices. In general, use of the term “output device” is intended to include all possible types of devices and ways to output information from computer system 510 to the user or to another machine or computer system. The computer system further can include user interface output devices 578 for communication with user equipment.

Storage subsystem 526 stores the basic programming and data constructs that provide the functionality of certain embodiments of the present invention. For example, the various modules implementing the functionality of certain embodiments of the invention may be stored in a storage subsystem 526. These software modules are generally executed by processor subsystem 572.

Storage subsystem 526 typically includes a number of memories including a main random access memory (RAM) 534 for storage of instructions and data during program execution and a read only memory (ROM) 532 in which fixed instructions are stored. File storage subsystem 536 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs, and may be stored by file storage subsystem 536. The host memory storage subsystem 526 contains, among other things, computer instructions which, when executed by the processor subsystem 572, cause the computer system to operate or perform functions as described herein. As used herein, processes and software that are said to run in or on “the host” or “the computer”, execute on the processor subsystem 572 in response to computer instructions and data in the host memory storage subsystem 526 including any other local or remote storage for such instructions and data.

Bus subsystem 550 provides a mechanism for letting the various components and subsystems of computer system 510 communicate with each other as intended. Although bus subsystem 550 is shown schematically as a single bus, alternative embodiments of the bus subsystem may use multiple busses.

Computer system 510 itself can be of varying types including a personal computer, a portable computer, a workstation, a computer terminal, a network computer, a television, a mainframe, or any other data processing system or user device. Due to the ever changing nature of computers and networks, the description of computer system 510 depicted in FIG. 5 is intended only as a specific example for purposes of illustrating embodiments of the present invention. Many other configurations of computer system 510 are possible having more or less components than the computer system depicted in FIG. 5.

### Some Particular Implementations

Some particular implementations and features are described in the following discussion.

In one implementation, the disclosed technology includes a method of testing a wireless device (DUT), including loading the DUT with a designation of a test Access Point Name, abbreviated APN, to access through a cellular wireless network; the test APN names a test P-GW controlled by a testing entity; and the name of the test P-GW is resolvable by accessing a GRX or cache from a GRX. The test P-GW is specially adapted to testing and providing control over tests; with the DUT initiating contact with the wireless network to establish an end-to-end IP connection from the DUT through the test P-GW designated by the test APN; and receiving from the test P-GW a test-stimulus selected from a group of: error conditions during establishment of a valid communication channel; attack messages and payloads; and a valid communication channel with a test server and message exchanges on the valid communication channel; and recording responses of the DUT interaction with or via the test P-GW. For some implementations, the end-to-end test includes an IMS test scenario. In some implementations, the test server is an IMS server. In one implementation of the disclosed method, the end-to-end test includes an application test with an application server on a non-public network. In yet another implementation, the disclosed method includes testing a prototype wireless device (DUT).

In other implementations, the disclosed technology includes a method of testing a wireless device (DUT), that includes loading the DUT with a designation of a test APN to access through a WiFi calling network; the test APN names a test ePDG and a test P-GW controlled by a testing entity; the test ePDG implements a trust layer for a signal from an untrusted WiFi access point; and the name of the test P-GW is resolvable by accessing a GRX or cache from a GRX. The disclosed test P-GW is specially adapted to testing and providing control over tests. The method also includes the DUT initiating contact with the wireless network to establish an end-to-end IP connection from the DUT through the test P-GW designated by the test APN; and receiving from the test APN error conditions and recording response of the DUT to the error conditions. For the disclosed method, the name of the test ePDG is resolvable by accessing a GRX or cache from a GRX.

For another implementation, the disclosed method of testing a wireless device (DUT) includes loading the DUT with a designation of a test APN to access through a WiFi calling network; the test APN names a test ePDG and a test P-GW controlled by a testing entity; the test ePDG implements a trust layer for a signal from an untrusted WiFi access point; and the name of the test P-GW is resolvable by accessing a GRX or cache from a GRX. For the disclosed method, the test P-GW is specially adapted to testing and providing control over tests; the DUT initiating contact with the wireless network to establish an end-to-end IP connection from the DUT through the test P-GW designated by the test APN; and receiving from the test APN attack messages and payloads and recording responses of the DUT to the APN the attack messages and payloads.

Some disclosed methods of testing a wireless device (DUT) include loading the DUT with a designation of a test APN to access through a WiFi wireless network; the test APN names a test P-GW controlled by a testing entity; and the name of the test P-GW is resolvable by accessing a GRX or cache from a GRX. For the disclosed method, the test P-GW is specially adapted to testing and providing control over tests; with the DUT initiating contact with the wireless network to establish an end-to-end IP connection from the DUT through the test P-GW designated by the test APN; and receiving from the test APN a valid communication channel and performing an end-to-end test between the DUT and a test server. For the disclosed method, the end-to-end test includes a throughput test over the valid communication channel. In some implementations, the end-to-end test includes an IMS test scenario′ and in some cases, the test server is an IMS server. In one implementation, the end-to-end test includes an application test with an application server on a non-public network. The disclosed method can further include testing a prototype wireless device (DUT).

In some implementations, a disclosed method of testing a wireless device (DUT), includes loading the DUT with a designation of a test IMS CSCF domain name to access through a wireless calling network that is a cellular wireless network or a data channel of a WiFi calling network. The data channel can include voice as VoIP. The test IMS CSCF domain name specifies a test IMS Network controlled by a testing entity; and the name of the test IMS CSCF is resolvable by accessing a DNS or cache from a DNS. For the disclosed method, the test IMS Network is specially adapted to testing and providing control over tests; with the DUT initiating contact with the wireless network to establish an end-to-end IMS Session from the DUT through the test IMS Network designated by the test IMS CSCF domain name; and receiving from the test IMS Network error conditions and recording response of the DUT to the error conditions. The disclosed method further includes receiving from the test IMS Network a valid communication channel and performing SIP Protocol tests. The method yet further includes receiving from the test IMS Network a valid communication channel and performing inter-carrier interoperability tests. The disclosed method can further include testing a prototype wireless device (DUT).

In one implementation, a disclosed method of testing a wireless DUT, includes loading the DUT with a designation of a test IMS CSCF domain name to access through a WiFi wireless network. The test IMS CSCF domain name specifies a test IMS Network controlled by a testing entity; the name of the test IMS CSCF is resolvable by accessing a DNS or cache from a DNS; and the test IMS Network is specially adapted to testing and providing control over tests. The disclosed method also includes the DUT initiating contact with the wireless network to establish an end-to-end IMS Session from the DUT through the test IMS Network designated by the test IMS CSCF domain name; and receiving from the test IMS Network error conditions and recording response of the DUT to the error conditions. For the disclosed method the name of the test ePDG is resolvable by accessing a GRX or cache from a GRX. The method can further include receiving from the test IMS Network a valid communication channel and performing SIP Protocol tests, and can also include receiving from the test IMS Network a valid communication channel and performing inter-carrier interoperability tests. The disclosed method can further include testing a prototype wireless device (DUT).

In yet another implementation a disclosed system addressed via a test APN, includes a test P-GW accessed via a public cellular or WiFi calling network that implements; testing of initial connection error conditions by responding to initial connection requests from a DUT with error condition codes; and coordination of testing of the DUT and recording of DUT responses to the error condition codes. The disclosed system also includes a test IMS Network that implements testing of end-to-end channel conditions between the DUT and a test server; and coordination of testing of the DUT and recording of DUT performance during the testing of end-to-end channel conditions. In some implementations of the disclosed system, the test APN name is resolvable to the test P-GW by accessing a GRX or cache from a GRX. The disclosed system further includes a test ePDG accessed from an untrusted WiFi access point, which implements a trust layer between the untrusted WiFi access point and the test P-GW; and coordination of testing of the DUT and recording of DUT at the trust layer, wherein a domain name is resolvable to the test ePDG by accessing a DNS resolver or cache from a DNS resolver. For some implementations of the disclosed system, the test APN is resolvable to the test P-GW by accessing a Global Roaming Exchange, abbreviated GRX, or cache from a GRX, or by accessing a routing table provided by the public cellular network.

This system and other implementations of the technology disclosed can include one or more of the features and/or features described in connection with any of the methods disclosed. In the interest of conciseness, the combinations of features disclosed in this application are not individually enumerated and are not repeated with each base set of features. The reader will understand how features identified in this section can readily be combined with sets of base features identified as implementations.

Other implementations may include a system according to any of the preceding systems, described above.

Yet other implementations include a computer readable media with a tangible non-transitory computer readable storage medium storing instructions executable by a processor to control a system as described above. A tangible non-transitory computer readable medium does not include a transitory wave form.

We claim as follows:

1. A system addressed via a test Access Point Name, abbreviated APN, including:
a test Packet Data Network Gateway, abbreviated P-GW, accessed via a public cellular or WiFi calling network that implements
testing of initial connection error conditions by responding to initial connection requests from a DUT with error condition codes; and
coordination of testing of the DUT and recording of DUT responses to the error condition codes; and
a test IP Multimedia Subsystem, abbreviated IMS, network that implements
testing of end-to-end channel conditions between the DUT and a test server; and
coordination of testing of the DUT and recording of DUT performance during the testing of end-to-end channel conditions.

2. The system of claim 1, wherein the test APN is resolvable to the test P-GW by accessing a Global Roaming Exchange, abbreviated GRX, or cache from a GRX.

3. The system of claim 1, wherein the test APN is resolvable to the test P-GW by accessing a routing table provided by the public cellular network.

4. The system of claim 1, further including a test Evolved Packet Data Gateway, abbreviated ePDG, accessed from an untrusted WiFi access point, which implements
a trust layer between the untrusted WiFi access point and the test P-GW; and
coordination of testing of the DUT and recording of DUT at the trust layer.

5. The system of claim 4, wherein a domain name is resolvable to the test ePDG by accessing a DNS resolver or cache from a DNS resolver.

6. A method of testing a wireless DUT, including:
loading the DUT with a designation of a test APN to access through a cellular wireless network, wherein
the test APN identifies a test P-GW controlled by a testing entity and is resolvable to a test P-GW by querying a GRX or cache from a GRX and
the test P-GW is specially adapted to testing and providing control over tests;
the DUT initiating contact with the wireless network to establish an end-to-end IP connection from the DUT through the test P-GW designated by the test APN; and
receiving from the test P-GW a test-stimulus selected from a group of:
error conditions during establishment of a valid communication channel;
attack messages and payloads; and
a valid communication channel with a test server and message exchanges on the valid communication channel; and
recording responses of the DUT interacting with or via the test P-GW.

7. The method of claim 6, wherein the test-stimulus selected is the error conditions during establishment of a valid communication channel.

8. The method of claim 6, wherein the test-stimulus selected is the attack messages and payloads.

9. The method of claim 6, wherein the test-stimulus selected is the valid communication channel with a test server and message exchanges on the valid communication channel.

10. The method of claim 9, further including performing an end-to-end test over the end-to-end IP connection wherein the end-to-end test includes a throughput test over the valid communication channel.

11. The method of claim 9, further including performing an end-to-end test over the end-to-end IP connection wherein the end-to-end test includes an IMS test scenario.

12. The method of claim 9, wherein the test server is an IMS server.

13. The method of claim 9, further including performing an end-to-end test over the end-to-end IP connection wherein the end-to-end test includes an application test with an application server on a non-public network.

14. The method of claim 6, further including testing a prototype wireless device (DUT).

15. A tangible non-transitory computer readable medium with instructions that are combinable with a processor and memory coupled to the processor to carry out a method according to claim 6.

16. A method of testing a wireless DUT, including:
providing the DUT with a designation of a test APN and a designation of a test ePDG, to access through a WiFi wireless network, wherein
the test APN identifies a test P-GW controlled by a testing entity and is resolvable to the test P-GW by querying a GRX or cache from a GRX;
the test P-GW is specially adapted to testing and providing control over tests;
the designation of the test ePDG is resolvable by querying a DNS; and
the test ePDG implements a trust layer for a signal from an untrusted WiFi access point;
the DUT initiating contact with the test ePDG via the WiFi wireless network to establish an end-to-end IP connection from the DUT through the test P-GW designated by the test APN; and
the DUT receiving from the test P-GW a test-stimulus selected from a group of:
error conditions during establishment of a valid communication channel;
attack messages and payloads; and
a valid communication channel with a test server and message exchanges on the valid communication channel; and
recording responses of the DUT interacting with or via the test P-GW.

17. The method of claim 16, wherein the test-stimulus selected is the error conditions during establishment of a valid communication channel.

18. The method of claim 16, wherein the test-stimulus selected is the attack messages and payloads.

19. The method of claim 16, wherein the test ePDG is resolvable by accessing a GRX or cache from a GRX or routing table provided by the WiFi wireless network.

20. The method of claim 16, further including performing an end-to-end test over the end-to-end IP connection of an IMS scenario.

21. The method of claim 16, further including performing an end-to-end test over the end-to-end IP connection with an IMS server acting as the test server.

22. A tangible non-transitory computer readable medium with instructions that are combinable with a processor and memory coupled to the processor to carry out a method according to claim 16.

23. A method of testing a wireless DUT, including:
loading the DUT with a designation of a test IMS Call Session Control Function, abbreviated CSCF, domain name to access through a wireless calling network that is a cellular wireless network or a voice or data channel of a WiFi calling network, wherein:
the test IMS CSCF domain name specifies a test IMS network controlled by a testing entity;
the domain name of the test IMS CSCF is resolvable by accessing a DNS or cache from a DNS; and
the test IMS Network is specially adapted to testing and providing control over tests;
the DUT initiating contact with the wireless network to establish an end-to-end IMS Session from the DUT through the test IMS Network designated by the test IMS CSCF domain name; and
receiving from the test IMS Network, error conditions and recording response of the DUT to the error conditions.

24. The method of claim 23, further including receiving from the test IMS Network a valid communication channel and performing SIP Protocol tests.

25. The method of claim 23, further including receiving from the test IMS Network a valid communication channel and performing inter-carrier interoperability tests.
